(19) United States
(12) Patent Application Publication
(10) Pub. No.: US 2025/0047515 A1
(43) Pub. Date: Feb. 6, 2025

(54) BLOCKCHAIN-BASED INDUSTRIAL INTERNET OF THINGS DATA MANAGEMENT AND OPTIMIZATION SYSTEM AND METHOD

(71) Applicant: QINGDAO UNIVERSITY OF TECHNOLOGY, Qingdao (CN)

(72) Inventors: Jinlong Wang, Qingdao (CN); Yixin Li, Qingdao (CN); Yunting Wu, Qingdao (CN); Xiaoyun Xiong, Qingdao (CN); Yuanyuan Zhang, Qingdao (CN)

(21) Appl. No.: 18/912,417

(22) Filed: Oct. 10, 2024

(30) Foreign Application Priority Data
Apr. 29, 2024 (CN) 202410529291.7

(51) Int. Cl. H04L 9/00; G06F 17/16; G16Y 40/10; G16Y 40/50

(52) U.S. Cl. CPC H04L 9/50; G06F 17/16; G16Y 40/10; G16Y 40/50

(57) ABSTRACT

The present invention discloses a blockchain-based Industrial Internet of Things (IIoT) data management system and method, where the system includes a physical layer, an edge layer, a network interface layer and a cloud layer; the physical layer includes a plurality of different IIoT device monitoring systems; the edge layer is configured to build an IIoT blockchain network; the cloud layer includes cloud servers which are configured to be deployed in a real blockchain network environment to improve performance and effectiveness of the blockchain network. The present invention can effectively solve the problem of parameter optimization lag in industrial production applications.

### TECHNICAL FIELD

The present invention pertains to the field of blockchain technology and Industrial Internet of Things (IIoT), and particularly pertains to a blockchain-based IIoT data management and optimization system and method.

### BACKGROUND

Combining the blockchain technology with industrial data management can ensure reliability of data during monitoring. This means that in an entire fault monitoring process, from data acquisition, transmission to analysis, each link can be reliably recorded and verified, thus significantly improving transparency and reliability of the data. However, with the introduction of 6G technology in the future, the real-time performance and dynamicity of the network will be further improved. At the same time, the inherent performance bottlenecks of the blockchain technology also lead to data processing latency, making performance optimization a key challenge.

In current solutions, although reinforcement learning algorithms are applied to blockchain performance optimization, parameter tuning lags due to long training time and delayed feedback cycles. In addition, existing solutions lack effective policy for multi-level industrial data processing because industrial monitoring data come from equipment of different importance, and a large number of normal monitoring data will hinder the timely processing of abnormal data.

### SUMMARY

In order to solve the above-mentioned technical problems, the present invention provides a blockchain-based Industrial Internet of Things (IIoT) data management and optimization system and method which uses a generative model based on a Transformer architecture to predict a future transaction transmission rate and dynamically tunes blockchain network parameters according thereto, which can effectively solve the problem of parameter optimization lag in industrial production applications.

In order to achieve the above object, the present invention uses the following technical solution:

A blockchain-based Industrial Internet of Things (IIoT) data management and optimization system, includes a physical layer, an edge layer, a network interface layer and a cloud layer;

the physical layer includes a plurality of different IIoT device monitoring systems;

the edge layer includes an edge server and an edge gateway, the edge server and the edge gateway serve as nodes of a blockchain and are configured to build a an IIoT blockchain network; the IIoT blockchain network processes data storage transaction requests of different IIoT device monitoring systems; the edge gateway is responsible for information transmission and data processing tasks between the physical layer and the edge server; the edge server is responsible for collecting performance and parameter data from the IIoT blockchain network, and preprocessing the collected data to ensure accuracy and consistency of the data; and the edge server is also deployed with a Transformer-based generative model which is configured to predict a blockchain transaction volume in a future period of time according to the preprocessed data to obtain a prediction result, and the prediction result will be configured to simulate an environment configuration for the blockchain;

the network interface layer includes a blockchain service interface and a 6G network communication interface, which are responsible for communication connection and blockchain service between the edge layer and the cloud layer, and the blockchain service interface is deployed with a smart contract interface; and

the cloud layer includes cloud servers which, in a cloud server cluster, receive the prediction result from the edge server, deploy an environment simulating the blockchain based on the prediction result, and configure a stress test tool for interactive training of an reinforcement learning algorithm, and during the interactive training, the reinforcement learning algorithm selects optimal configuration parameters based on a state of the blockchain network for deployment in a real IIoT blockchain network environment to improve performance and effectiveness of the blockchain network.

In the solution described above, the Transformer-based generative model includes a unified input representation layer, an encoder, a decoder, a fully connected layer and an output processing layer; the unified input representation layer is configured to transform the data to generate a representation vector input into the model; the encoder includes two multi-head ProbeSparse self-attention layers, each multi-head ProbeSparse self-attention layer is immediately followed by a feedforward neural network, and the encoder is configured to perform feature extraction processing and output a feature representation of a historical sequence; the decoder includes a masked multi-head ProbeSparse self-attention layer, a multi-head attention layer and a concatenation layer, and the decoder is configured to fuse a feature extraction result output by the encoder and output a prediction sequence vector; the fully connected layer is configured for feature transformation to transform an internal feature of the model into a prediction result useful for an outer world; and the output processing layer is configured to perform inverse normalization processing on a prediction sequence and output the prediction sequence.

A blockchain-based IIoT data management and optimization method, uses the blockchain-based IIoT data management and optimization system described above, includes the following steps:

S1, deploying a blockchain running environment in an edge gateway and an edge server, and building an IIoT blockchain network using the edge gateway and the edge server as blockchain nodes;

S2, collecting, by the edge server, performance and parameter data of the IIoT blockchain network and preprocessing the collected data;

S3, inputting the preprocessed data into a Transformer-based generative model to predict a blockchain transaction volume in a future period of time;

S4, deploying a training environment simulating a blockchain in a cloud server according to the predicted blockchain transaction volume in the future period of time;

S5, configuring algorithm related operation parameters, interacting with the environment simulating the blockchain configured in the cloud server to train a reinforcement learning algorithm, and outputting configuration parameters of the blockchain network at the moment when the reinforcement learning algorithm training process converges or reaches a time prediction window; and

S6, in a real IIoT blockchain network environment, deploying parameters optimized in the environment simulating the blockchain to the real environment in case of traffic fluctuation of the blockchain; or abandoning parameter tuning in case of no traffic fluctuation, and repeating steps S2 to S5 to continue a next stage of predictive optimization.

In the solution described above, a specific method of step S3 is as follows:

Step 1: the preprocessed data passes through a unified input representation layer for data transformation to generate a representation vector input into the model;

Step 2: the representation vector output by the unified input representation layer is put into an encoder for feature extraction processing and a feature representation of a historical sequence is output;

Step 3: a decoder fuses a feature extraction result output by the encoder to output a prediction sequence vector;

Step 4: the prediction sequence vector passes through a fully connected layer for feature transformation to transform an internal feature of the model into a prediction result useful for an outer world; and

Step 5: an output processing layer performs inverse normalization processing on the prediction result and outputs the prediction result.

In a new technical solution, a specific processing process of Step 1 is as follows:

the unified input representation layer realizes data transformation by combining a global time embedding SE and a local time embedding PE, thus generating a representation vector x^{t}_{feed} input into the model:

$${x}_{feed [ m ]}^{t} = α {x}_{m}^{t} + {PE}_{( N * ( t - 1 ) + m )} + {\sum }_{p} {[ {SE}_{( N * ( t - 1 ) + m )} ]}_{p}$$

where α is a scalar factor configured to balance importance between feature mapping and time embedding, N is a number of samples, m∈[1, N] represents a sample index, and p and t respectively represent a global time type and a number of input sequences; and the global time embedding is represented by a learnable embedding SEₚₒₛ, while the local time embedding is a fixed position embedding in Transformer which is calculated using the following formula:

$${PE}_{( pos , 2 n )} = sin ( \frac{p o s}{{( 2 N )}^{2 n / {d}_{model}}} )$$

$${PE}_{( pos , 2 n + 1 )} = cos ( \frac{p o s}{{( 2 N )}^{2 n / {d}_{model}}} )$$

where n∈[1, . . . , d_{model}/2], pos represents positional information, and d_{model} is a characteristic dimension of the input representation.

In a new technical solution, a specific processing process of Step 2 is as follows:

firstly, the encoder receives x^{t}_{feed} from the unified input representation layer and inputs the same into a multi-head ProbeSparse self-attention layer I, and a calculation formula thereof is:

$$ProbeSparse\_Att ( Q , K , V ) = Softmax ( \frac{\overline{Q} {K}^{T}}{\sqrt{{d}_{model}}} ) V$$

where Q is a sparse matrix of the same size as Q, and only contains first u most relevant queries under a sparsity metric M(qᵢ, K); and Q∈R^{N×d}^{_{model}}, K∈R^{N×d}^{_{model}} and V∈R^{N×d}^{_{model}} respectively represent a query vector, a key vector and a value vector; these vectors are obtained by performing linear transformation on the input feature, that is, [Q, K, V]=[X^{t}_{feed}·W_{Q}, X^{t}_{feed}·W_{K}, X^{t}_{feed}·W_{V}], where W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V; and d_{model} is a characteristic dimension of the input representation;

where a formula of the sparsity metric M(qᵢ, K) is as follows:

$$M ( {q}_{i} , K ) = ln {\sum }_{{j = 1}^{}}^{{L}_{K}} {e}^{\frac{{q}_{i} {k}_{j}}{\sqrt{d}}} - \frac{1}{{L}_{K}} {\sum }_{j = 1}^{{L}_{K}} \frac{{q}_{i} {k}_{j}}{\sqrt{d}}$$

where qᵢ represents an ith query vector, K represents a key matrix, kⱼ represents a jth key vector in K, L_{K} represents a length of the key K which is a number of keys, and d is a characteristic dimension of the input;

after processing by the multi-head ProbeSparse self-attention layer I, a feedforward neural network layer I is used for further operation processing; operation steps of the feedforward neural network are as follows: firstly, a convolutional neural network is used to extract advanced features of the data, and then, a length of the sequence is reduced by max pooling operation, and a specific process is represented as:

$${X}_{q + 1}^{t} = MaxPool ( ELU ( Conv 1 {d [ {X}_{q}^{t} ]}_{AB} ) )$$

where Conv1d represents one-dimensional convolutional operation, ELU is an activation function, and MaxPool is a max pooling function, [X_{q}^{t}]_{AB} is an output of the multi-head Probesparse self-attention layer I, and X_{q+1}^{t} is an output of the multi-head ProbeSparse self-attention layer I; next, after further feature processing by a multi-head Probesparse self-attention layer II and a feedforward neural network layer II with the same structure as above, the features are concatenated and used as an output X_{Encoder}^{t} of the encoder, and a formula thereof is expressed as follows:

$${X}_{Encoder}^{t} = Concat ( FFN 2 ( Probesparse\_Att2 ( {X}_{q + 1}^{t} ) ) )$$

In a new technical solution, a specific processing process of Step 3 is as follows:

firstly, a start marker X^{t}ₜₒₖₑₙ of the sequence and a placeholder X^{t}₀ of the prediction sequence are input, and these two pieces of data are combined into an input vector of the decoder through a concatenation operation; the start marker indicates the start of the prediction sequence, and the placeholder X^{t}₀ reserves a position for a future prediction value, and a formula thereof is as follows:

$${X}_{de}^{t} = F e a t u r e C o n c a t ( {X}_{token}^{t} , {X}_{0}^{t} ) ∈ {R}^{( {N}_{token} + {N}_{y} ) \times {d}_{model}}$$

where Nₜₒₖₑₙ is a length of the start marker, and N_{y} is a length of a placeholder of a prediction sequence y; d_{model} is the characteristic dimension of the input representation of the model; X_{de}^{t} represents an input of the decoder at time t, Xₜₒₖₑₙ^{t} represents a start marker of a sequence at time t, and X₀^{t} represents a placeholder of a prediction sequence at time t;

the input data X_{de}^{t} first passes through the masked multi-head ProbeSparse self-attention layer to ensure that the model can only access the information before a current time step when generating prediction for each time step, where a formula of the masked multi-head ProbeSparse self-attention layer is expressed as follows:

$$Mask\_ProbeSparse \_Att ( Q , K , V , M ) = Softmax ( \frac{\overline{Q} {K}^{T}}{\sqrt{{d}_{model}}} ▯ M ) V$$

where || represents an element multiplication, M is a masked matrix with a shape the same as Q̅K^{T} and the rest of the letters having the same meanings as those of the multi-head ProbeSparse self-attention layer; and the output of the masked multi-head ProbeSparse attention layer is Xₘₐₛₖ;

then Xₘₐₛₖ is put into the multi-head self-attention layer for enhancement processing, and an output result is Attention(Xₘₐₛₖ), and a formula of the multi-head self-attention layer is expressed as follows:

$$Attention ( Q , K , V ) = Softmax ( \frac{Q {K}^{T}}{\sqrt{{d}_{model}}} ) V$$

where Q∈R^{N×d}^{_{model}}, K∈R^{N×d}^{_{model}} and V∈R^{N×d}^{_{model}} respectively represent a query vector, a key vector and a value vector; these vectors are obtained by performing linear transformation on the input feature; that is, [Q, K, V]=[Xₘₐₛₖ^{t}·W_{Q}, Xₘₐₛₖ^{t}·W_{K}, Xₘₐₛₖ^{t}·W_{V}]; where W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V;

then the data Attention(Xₘₐₛₖ) output by the multi-head self-attention layer and an output X_{Encoder}^{t} of the encoder are subject to feature concatenation by a concatenation layer to

further integrate context information from the encoder, and an output is X_{Con} which is represented as follows:

X_{Con}=Concat(Attention(Xₘₐₛₖ), X_{Encoder}^{t})

In a new technical solution, in Step 4, the concatenated data X_{Con} is subject to feature transformation by the fully connected layer, and the layer outputs a prediction sequence for a future sequence X_{t+K}, where K represents a length of the predicted future sequence, a formula thereof is expressed as follows:

$${X}_{t + K} = Fc ( {X}_{Con} ) ;$$

in Step 5, the prediction sequence X_{t+K} is subject to inverse normalization processing by the output processing layer, and a formula of the inverse normalization processing is:

$${X}_{t + K}^{′} = {X}_{t + K} \cdot ( max ( X ) - min ( X ) ) + min ( X )$$

where X′_{t+K}represents a prediction of the blockchain transaction volume in the future period of time based on historical and current states, and the prediction result will be configured to simulate an environment configuration for a blockchain, and K represents the length of the predicted future sequence.

In a new technical solution, in step S4, the operation of deploying the environment simulating the blockchain includes the following steps:

Step 1: environment configuration file modification: modifying a network node configuration file and a smart contract storage scale configuration file according to a number of blockchain network nodes and node organization information and channel configuration condition collected in step S2;

Step 2: configuring and starting a Hyperledger Fabric network, defining an organization and nodes, then generating a network configuration file and an encryption material, and then starting network services comprising ordering services, node consensus services and chain code installation deployment;

Step 3: using Prometheus to monitor state of the blockchain nodes, and acquiring state information of each current blockchain node; and

Step 4: starting a stress test tool Caliper and obtaining performance test results of an initial blockchain network.

In a new technical solution, in step S5, the reinforcement learning algorithm training parameter tuning process includes the following steps:

Step 1: initializing online and target networks of Actor and Critic for agents of two node types, and then initializing a random exploration action process Nₚ, monitoring the deployed Hyperledger Fabric network, receiving the collected initial state s and performing standardization processing;

Step 2: performing actions according to an agent policy: in each iteration, each agent selects an action αᵢ according to the policy π(αᵢ) and exploration noise N;

Step 3: deploying new blockchain network parameters and restarting the Hyperledger Fabric network according to the agent action;

Step 4: using the stress test tool Caliper to test performance of the Hyperledger Fabric to calculate a reward obtained by a currently performed action; and after the reward value is obtained by calculating, taking an average value to allocate to each agent;

Step 5: monitoring the Prometheus and collecting a new blockchain network state s′;

Step 6: storing an experience tuple: storing the current state s, the executed action α, the reward r and a new state s′ as a tuple (s, α, r, s′), and placing the tuple in an experience replay buffer D;

Step 7: extracting, by the Critic network, actions and observation information of itself and other agents from the experience replay buffer D to train a centralized action value network Q_{P}.

Step 8: updating a parameter of the Actor network based on a gradient ascent method, and then softly updating parameters of their target networks, that is, after every certain number of iteration steps, the parameters of the online network are directly assigned to the target network; and

Step 9: in the training phase, when throughput of five consecutive feedbacks changes by less than 5 tps, or the training time has reached a previously preset time window, output action parameters at this time are recorded and used as optimization parameters for predictive tuning.

With the technical solutions described above, the system and method for managing and optimizing IIoT data based on blockchains provided by the present invention have the following beneficial effects:

The present invention proposes an IIoT data management framework combined with blockchain, which, for the performance bottleneck problem of blockchain, uses an enhanced learning model to perform parameter tuning, and dynamically tunes configuration parameters of a blockchain network, thus optimizing performance and scalability of the blockchain-based IIoT data management system.

By further combining a generative model based on Transformer architecture, the present invention enables accurate prediction of future blockchain transaction volume. The application of this technology allows predictive parameter optimization for the blockchain network, enabling optimized parameters to be deployed to the production environment in a timely manner. Therefore, it can effectively deal with transaction latency problem during peak periods of industrial production, and ensure stability and efficiency of the blockchain network under high load conditions.

### BRIEF DESCRIPTION OF THE DRAWINGS

In order to illustrate the technical solutions of the embodiments of the present invention or the prior art more clearly, the accompanying drawings required for the description of the embodiments or the prior art will be briefly introduced below.

FIG. 1 is a schematic diagram of a blockchain-based IIoT data management and optimization system disclosed in an embodiment of the present invention.

FIG. 2 is a structural diagram of a Transformer-based generative model.

FIG. 3 is a process flow diagram of a blockchain-based IIoT data management and optimization method.

FIG. 4 is a flow chart of a blockchain-based IIoT data management and optimization method.

FIG. 5 is a prediction flow chart of a Transformer-based generative model.

FIG. 6 is a flow chart of configuring an environment simulating a blockchain in a cloud server.

FIG. 7 is a flow chart of reinforcement learning training and parameter tuning.

### DESCRIPTION OF THE EMBODIMENTS

The technical solutions in the embodiments of the present invention will be described clearly and completely below with reference to the accompanying drawings in the embodiments of the present invention.

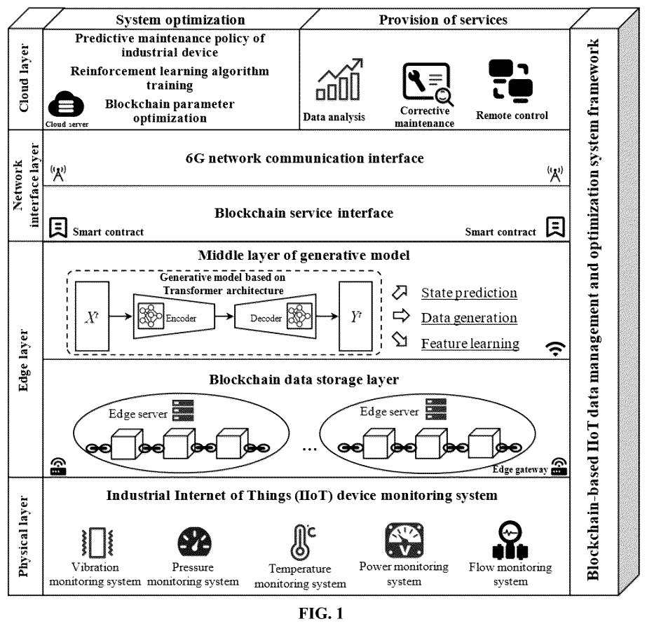

The present invention provides a blockchain-based Industrial Internet of Things (IIoT) data management and optimization system which, as shown in FIG. 1, includes a physical layer, an edge layer, a network interface layer and a cloud layer.

The physical layer includes a plurality of different IIoT device monitoring systems, such as a vibration monitoring system, a pressure monitoring system, a temperature monitoring system, a power monitoring system and a flow monitoring system.

The edge layer includes an edge server and an edge gateway, the edge server and the edge gateway serve as nodes of a blockchain and are configured to build a an IIoT blockchain network; the IIoT blockchain network processes data storage transaction requests of different IIoT device monitoring systems; the edge gateway is responsible for information transmission and data processing tasks between the physical layer and the edge server; the edge server is responsible for collecting performance and parameter data from the IIoT blockchain network, and preprocessing the collected data to ensure accuracy and consistency of the data; and the edge server is also deployed with a Transformer-based generative model which is configured to predict a blockchain transaction volume in a future period of time according to the preprocessed data to obtain a prediction result, and the prediction result will be configured to simulate an environment configuration for the blockchain.

The network interface layer includes a blockchain service interface and a 6G network communication interface, which are responsible for communication connection and blockchain service between the edge layer and the cloud layer, and the blockchain service interface is deployed with a smart contract interface.

The cloud layer includes cloud servers which, in a cloud server cluster, receive the prediction result from the edge server, deploy an environment simulating the blockchain based on the prediction result, and configure a stress test tool for interactive training of an reinforcement learning algorithm, and during the interactive training, the reinforcement learning algorithm selects optimal configuration parameters based on a state of the blockchain network for deployment in a real IIoT blockchain network environment to improve performance and effectiveness of the blockchain network.

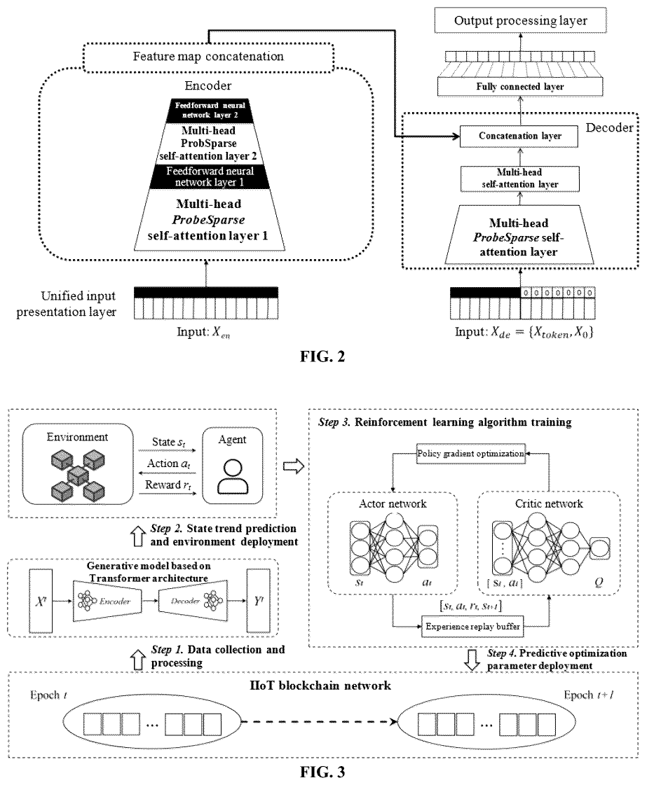

As shown in FIG. 2, the Transformer-based generative model includes a unified input representation layer, an encoder, a decoder, a fully connected layer and an output processing layer; the unified input representation layer is configured to transform the data to generate a representation vector input into the model; the encoder includes two multi-head ProbeSparse self-attention layers, each multi-head ProbeSparse self-attention layer is immediately followed by a feedforward neural network, and the encoder is configured to perform feature extraction processing and output a feature representation of a historical sequence; the decoder includes a masked multi-head ProbeSparse self-attention layer, a multi-head attention layer and a concatenation layer, and the decoder is configured to fuse a feature extraction result output by the encoder and output a prediction sequence vector; the fully connected layer is configured for feature transformation to transform an internal feature of the model into a prediction result useful for an outer world; and the output processing layer is configured to perform inverse normalization processing on a prediction sequence and output the prediction sequence.

A core architecture of the encoder portion consists of two special self-attention layers called ProbeSparse self-attention, which efficiently handle data dependencies over long time spans. This unique attention mechanism reduces computational complexity and improves efficiency in processing large-scale data sequences. Each self-attention layer is immediately followed by a feedforward neural network layer which is responsible for nonlinear transformations between layers. By introducing position encoding, the encoder can maintain sequence information of time series data, ensuring that the model does not ignore temporal dynamics in the series. Combining advanced attention technology and design of deep feedforward network, the encoder portion can not only capture long-term time dependence, but also focus on information segments that have the greatest impact on the future output during prediction, which can be effectively used to predict an arrival rate of IIoT data processing transactions.

The decoder portion also shows a high degree of optimization for long sequence prediction. It is designed through a series of self-attention and masked multi-head attention layers, and each layer is precisely tuned to process and predict future data points. The decoder first processes all generated outputs through the self-attention layer, which helps the model understand and exploit the time dependence of known outputs. The masked multi-head ProbeSparse self-attention layer enables the decoder to efficiently use context information generated by the encoder to highlight historical data points critical to subsequent predictions. In addition, the included feedforward neural network enhances processing capability and optimizes the data flow from input to output. This decoder architecture which combines an autoregressive generation method and a powerful attention mechanism exhibits excellent performance in the long sequence prediction.

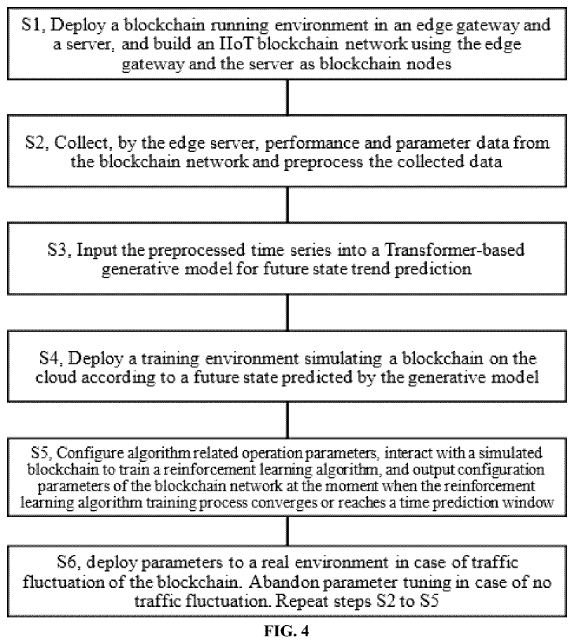

The present invention discloses a blockchain-based IIoT data management and optimization method which, as shown in FIGS. 3 and 4, includes the following steps:

S1, deploying a blockchain running environment in an edge gateway and an edge server, and building an IIoT blockchain network using the edge gateway and the edge server as blockchain nodes.

Specifically, in this architecture, simulating the blockchain environment and reinforcement learning algorithm training are mainly performed on the cloud, while the generative model prediction algorithm is deployed on the edge server. The IIoT blockchain network processes monitoring data generated during operation of different IIoT devices and data storage transaction requests of subsystems, such as a vibration monitoring system, a pressure monitoring system, a temperature monitoring system, a power monitoring system and a flow monitoring system.

S2, collecting, by the edge server, performance and parameter data of the IIoT blockchain network and preprocessing the collected data.

Specifically, in this step, the edge server is responsible for collecting performance and parameter data from the blockchain network. These data include monitoring data generated during operation of different IIoT devices, transaction transmission rates of current state and historical state of a blockchain, and node configuration data. The edge server also needs to preprocess the collected data to ensure accuracy and consistency of the data. Data normalization is used in the present invention so that the model helps to capture and learn subtle fluctuations in time series. Secondly, the time series is divided into multiple sequence blocks, and based on sliding window technology, sequence samples are created, which contain historical data of a specific length (input) and predicted length (output). A normalization formula is as follows:

$${X}_{n o r m a l i z e d} = \frac{max ( X ) - min ( X )}{X - min ( X )}$$

The preprocessed transaction transmission rates of the current state and the historical state of the blockchain will be used as inputs to the generative prediction model.

S3, inputting the preprocessed data into a Transformer-based generative model to predict a blockchain transaction volume in a future period of time.

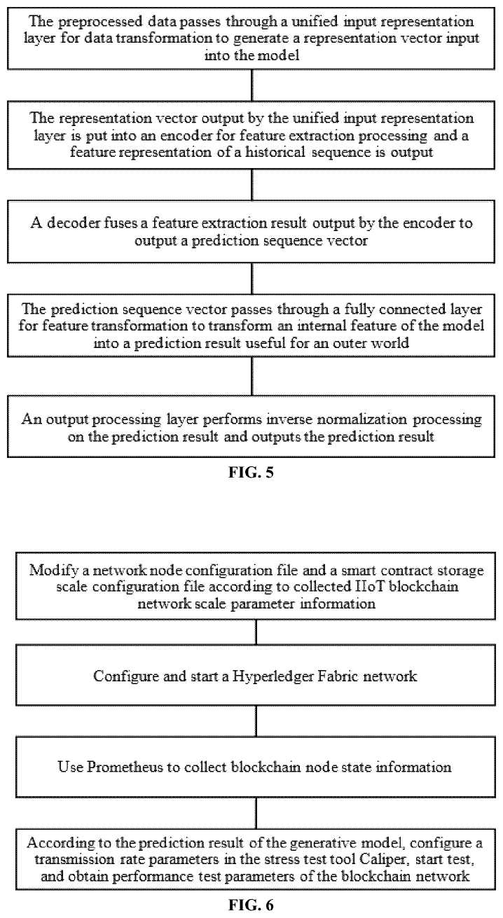

A specific process is as shown in FIG. 5, and includes the following steps:

Step 1: the preprocessed data passes through a unified input representation layer for data transformation to generate a representation vector input into the model.

The unified input representation layer realizes data transformation by combining a global time embedding SE and a local time embedding PE, thus generating a representation vector X^{t}_{feed} input into the model:

$${x}_{feed ⌈ m ⌉}^{t} = α {x}_{m}^{t} + {PE}_{( {N}^{*} ( t - 1 ) + m )} + {\sum }_{p} {[ S {E}_{( N * ( t - 1 ) + m )} ]}_{p}$$

Where α is a scalar factor configured to balance importance between feature mapping and time embedding, N is a number of samples, m∈[1, N] represents a sample index, and p and t respectively represent a global time type and a number of input sequences; and the global time embedding is represented by a learnable embedding SEₚₒₛ, while the local time embedding is a fixed position embedding in Transformer, and a calculation formula thereof is:

$$\begin{matrix}{PE}_{( pos , 2 n )} = sin ( \frac{p o s}{{( 2 N )}^{2 n / {d}_{model}}} ) \\ {PE}_{( pos , 2 n + 1 )} = cos ( \frac{p o s}{{( 2 N )}^{2 n / {d}_{model}}} )\end{matrix}$$

where n∈[1, . . . , d_{model}/2], pos represents positional information, and d_{model} is a characteristic dimension of the input representation.

Step 2: the representation vector output by the unified input representation layer is put into an encoder for feature extraction processing and a feature representation of a historical sequence is output.

Firstly, the encoder receives x^{t}_{feed} from the unified input representation layer and inputs the same into a multi-head ProbeSparse self-attention layer I, and a calculation formula thereof is:

$$ProbeSparse\_Att ( Q , K , V ) = Softmax ( \frac{\overline{Q} {K}^{T}}{\sqrt{{d}_{mdel}}} ) V$$

Where Q̅ is a sparse matrix of the same size as Q, and only contains first u most relevant queries under a sparsity metric M(qᵢ, K); and Q∈R^{N×d}^{_{model}}, K∈R^{N×d}^{_{model}} and V∈R^{N×d}^{_{model}} respectively represent a query vector, a key vector and a value vector; these vectors are obtained by performing linear transformation on the input feature, that is, [Q, K, V]=[X^{t}_{feed}·W_{Q}, X^{t}_{feed}·W_{K}, X^{t}_{feed}·W_{V}], where W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V; and d_{model} is a characteristic dimension of the input representation;

Where a formula of the sparsity metric M(qᵢ, K) is as follows:

$$M ( {q}_{i} , K ) = ln {\sum }_{j = 1}^{{L}_{K}} {e}^{\frac{{q}_{i} {k}_{i}}{\sqrt{d}}} - \frac{1}{{L}_{K}} {\sum }_{j = 1}^{{L}_{K}} \frac{{q}_{i} {k}_{j}}{\sqrt{d}}$$

where qᵢ represents an ith query vector, K represents a key matrix, kⱼ represents a jth key vector in K, L_{K} represents a length of the key K which is a number of keys, and d is a characteristic dimension of the input.

After processing by the multi-head ProbeSparse self-attention layer I, a feedforward neural network layer I is used for further operation processing; operation steps of the feedforward neural network are as follows: firstly, a convolutional neural network is used to extract advanced features of the data, and then, a length of the sequence is reduced by max pooling operation, and a specific process is represented as:

$${X}_{{q + 1}^{}}^{t} = MaxPool ( ELU ( Conv 1 {d [ {X}_{q}^{l} ]}_{AB} ) )$$

where Conv1d represents one-dimensional convolutional operation, ELU is an activation function, and MaxPool is a max pooling function, [X_{q}^{t}]_{AB} is an output of the multi-head Probesparse self-attention layer I, and X_{q+1}^{t} is an output of the multi-head ProbeSparse self-attention layer I; next, after further feature processing by a multi-head Probesparse self-attention layer II and a feedforward neural network layer II with the same structure as above, the features are concatenated and used as an output X_{Encoder}^{t} of the encoder, a formula thereof is expressed as follows:

$${X}_{Encoder}^{t} = Concat ( FFN 2 ( Probesparse\_Att2 ( {X}_{q + 1}^{t} ) ) ) .$$

Step 3: a decoder fuses a feature extraction result output by the encoder to output a prediction sequence vector.

Firstly, a start marker X^{t}ₜₒₖₑₙ of the sequence and a placeholder X^{t}₀ of the prediction sequence are input, and these two pieces of data are combined into an input vector of the decoder through a concatenation operation; the start marker indicates the start of the prediction sequence, and the placeholder X^{t}₀ reserves a position for a future prediction value, and a formula thereof is as follows:

$${X}_{d e}^{t} = FeatureConcat ( {X}_{token}^{t} , {X}_{0}^{t} ) ∈ {R}^{( {N}_{token} + {N}_{y} ) \times {d}_{model}}$$

where Nₜₒₖₑₙ is a length of the start marker, and N_{y} is a length of a placeholder of a prediction sequence y; d_{model} is the characteristic dimension of the input representation of the model; X_{de}^{t} represents an input of the decoder at time t, Xₜₒₖₑₙ^{t} represents a start marker of a sequence at time t, and X₀^{t} represents a placeholder of a prediction sequence at time t.

The input data X_{de}^{t} first passes through the masked multi-head ProbeSparse self-attention layer to ensure that the model can only access the information before a current time step when generating prediction for each time step, where a formula of the masked multi-head ProbeSparse self-attention layer is expressed as follows:

$$Mask\_ProbeSparse \_Att ( Q , K , V , M ) = Softmax ( \frac{\overline{Q} {K}^{T}}{\sqrt{{d}_{m o d e l}}} ▯ M ) V$$

where □ represents an element multiplication, M is a masked matrix with a shape the same as Q̅K^{T} and the rest of the letters having the same meanings as those of the multi-head ProbeSparse self-attention layer; and the output of the masked multi-head ProbeSparse attention layer is Xₘₐₛₖ.

Then Xₘₐₛₖ is put into the multi-head self-attention layer for enhancement processing, and an output result is Attention(Xₘₐₛₖ), and a formula of the multi-head self-attention layer is expressed as follows:

$$Attention ( Q , K , V ) = Softmax ( \frac{Q {K}^{T}}{\sqrt{{d}_{model}}} ) V$$

where Q∈R^{N×d}^{_{model}}, K∈R^{N×d}^{_{model}} and V∈R^{N×d}^{_{model}} and respectively represent a query vector, a key vector and a value vector; these vectors are obtained by performing linear transformation on the input feature; that is, [Q, K, V]=[Xₘₐₛₖ^{t}·W_{Q}, Xₘₐₛₖ^{t}·W_{K}, Xₘₐₛₖ^{t}·W_{V}]; where, W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V.

Then the data Attention(Xₘₐₛₖ) output by the multi-head self-attention layer and an output X_{Encoder}^{t} of the encoder are subject to feature concatenation by a concatenation layer to further integrate context information from the encoder, and an output is X_{Con} which is expressed as follows:

X_{Con}=Concat(Attention(Xₘₐₛₖ), X_{Encoder}^{t})

Step 4: the prediction sequence vector passes through a fully connected layer for feature transformation to transform an internal feature of the model into a prediction result useful for an outer world.

The concatenated data X_{Con} is subject to feature transformation by the fully connected layer, and the layer outputs a prediction sequence for a future sequence X_{t+K}, where K represents a length of the predicted future sequence, a formula thereof is expressed as follows:

$${X}_{t + K} = Fc ( {X}_{Con} ) .$$

Step 5: an output processing layer performs inverse normalization processing on the prediction result and outputs the prediction result.

The prediction sequence X_{t+K} is subject to inverse normalization processing by the output processing layer, and a formula of the inverse normalization processing is:

$${X}_{t + K}^{′} = {X}_{t + K} \cdot ( max ( X ) - min ( X ) ) + min ( X )$$

where X′_{t+K} represents a prediction of the blockchain transaction volume in the future period of time based on historical and current states, and the prediction result will be configured to simulate an environment configuration for a blockchain, and K represents the length of the predicted future sequence.

S4, deploying a training environment simulating a blockchain in a cloud server according to the predicted blockchain transaction volume in the future period of time.

The prediction generation information is transmitted to the cloud through the network interface layer, and a simulated environment of the blockchain is configured at the cloud according to the predicted future state to enhance learning and training interaction. Specifically, in a cloud server cluster, upon receiving information collected from edge servers, these data will be used to simulate the environment of an actual blockchain network and to configure stress test tools, such as configuring different transmission rates and transaction sizes.

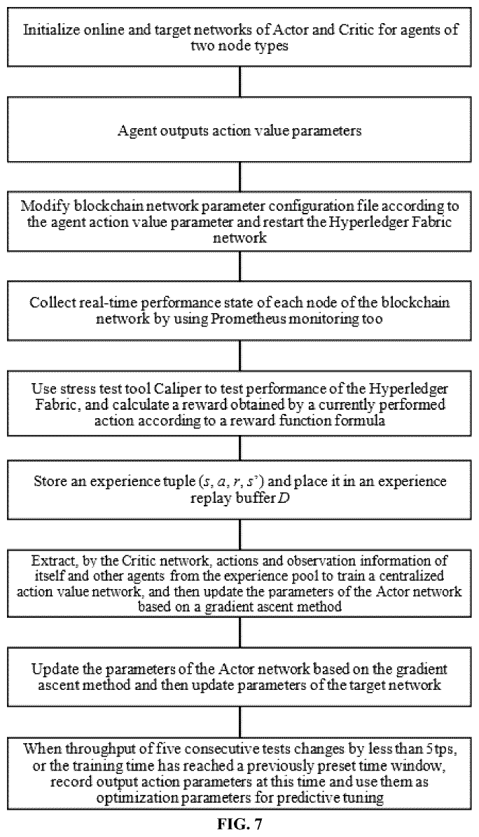

The corresponding process is as shown in FIG. 6. Specifically, the operation of deploying the environment simulating the blockchain includes the following step:

Step 1: environment configuration file modification. Specifically, a network node configuration file and a smart contract storage scale configuration file are modified according to a number of blockchain network nodes and node organization information and channel configuration condition collected in step S2.

Step 2: Configuring and starting a Hyperledger Fabric network; defining an organization and nodes are defined, and then generating a network configuration file and a cryptographic material, such as certificates and keys; and then starting network services including ordering services, node consensus services and chain code installation deployment.

Step 3: using Prometheus to monitor state of the blockchain nodes, and acquiring state information of each current blockchain node.

Specifically, a Prometheus instance is configured and started on the server, and metrics for collecting state information of the blockchain nodes are defined. Next, by running the Exporter program on the blockchain nodes, Prometheus will then periodically obtain the state information from the blockchain nodes and store the same in a time series database. Through a query function of Prometheus, node performance can be observed and analyzed in real time. This continuous monitoring provides critical data for subsequent reinforcement learning algorithms, which are used as state input parameters.

Step 4: starting a stress test tool Caliper and obtaining performance test results of an initial blockchain network.

Specifically, a network configuration file and a test configuration file are first written for performance test, where the network configuration file shall contain a test network name, actor roles, a smart contract name, and channel name settings. The test file contains detailed information of a test environment, a smart contract and a test workload which includes settings for transmission throughput, number and duration of concurrent threads. Among them, the transmission throughput is configured accordingly using the arrival rate of industrial monitoring data predicted in step S3.

Next, Caliper is started to evaluate performance and generate an initial set of performance test results, such as Hyperledger Fabric throughput, average transaction latency, maximum transaction latency, number of transaction successes, number of transaction failures, and resource usage (that is, traffic, average CPU and memory usage of nodes). This provides performance monitoring metrics of the blockchain network for calculation of a reward function in subsequent reinforcement learning algorithms.

S5, configuring algorithm related operation parameters, interacting with the environment simulating the blockchain configured in the cloud server to train a reinforcement learning algorithm, and outputting configuration parameters of the blockchain network at the moment when the reinforcement learning algorithm training process converges or reaches a time prediction window.

Specifically, the reinforcement learning algorithm is a multi-agent deep deterministic policy gradient optimization algorithm applied to optimization of block configuration parameters in the above-mentioned link. It should be noted that the present invention mainly focuses on parameter optimization for the Hyperledger Fabric framework. Among them, Hyperledger Fabric is an enterprise-level permissioned blockchain framework established under the Linux Foundation, and detailed design steps thereof include:

Step 1: proxy type design. In Hyperledger Fabric, peer nodes and ordering nodes are key roles in performing transactions and configuring network parameters. Thus, proxies are designed for the peer nodes and the ordering nodes.

Step 2: state space design. A state space consists of observations from the two types of nodes, represented as {Oₚ, Oₒ}. An observation Oₚ={Pₑₜ, Pᵥₜ, Pₛₜ, P_{c}, Pₛ} of a peer node proxy is defined. Specifically, the observation can be described as endorsement process Pₑₜ consumption (including chain code execution time in a simulation execution process, an endorsement proposal time), time consumption Pᵥₜ during verification (including communication latency between peer nodes, ledger verification latency), ledger storage latency Pₛₜ during submission and peer node computing storage capacities P_{c} and Pₛ. An observation Oₒ={O_{bt}, O_{ct}, Oₚₜ, O_{c}, Oₛ} of an ordering node proxy can be described as node broadcast latency O_{bt}, consensus submission latency O_{ct}, cluster processing latency Oₚₜ, node computing performance O_{c} and storage size Oₛ. In addition, in order to embody characteristics of the blockchain network, three state observations are additionally introduced in the state space: transaction size Ts, number of network nodes Numₚₑₑᵣ and Num_{order}.

Step 3: action space design. The configuration parameters of the blockchain nodes are regarded as an action, and a total of 11 parameters are selected. Among them, 5 parameters are configured for the peer nodes (buffer size for accepting blocks, endorsement communication transmission buffer size, gossip transmission interval between nodes and number of propagation nodes), 5 parameters are configured for the ordering nodes (including block size, block transmission interval, number of transactions contained in a block, block division interval and minimum block division transaction volume), and 1 parameter is configured for transaction, that is, transaction queue buffer size.

Step 4: reward function design. It is assumed that default parameter performance of the blockchain network is P, which includes throughput T and latency L. After a tth parameter tuning iteration, the network performance is tuned to Pₜ. To measure performance variations ΔP, a throughput variation ΔT and a system latency variation ΔL are defined. The variations are divided into two parts:
1) variations are ΔT_{t→0}=(Tₜ−T₀)/T₀ and ΔL_{t→0}=(−Lₜ, +L₀)/L₀ compared with an initial state;
2) variations are ΔT_{t→t-1}=(Tₜ−Tₜ₋₁)/Tₜ₋₁ and ΔL_{t→t-1}=(−Lₜ, +Lₜ₋₁)/Lₜ₋₁ compared with a previous moment.

Next, rewards r_{T} and r_{L} are calculated according to the throughput and latency performance variations respectively, as shown in the following formula:

$${r}_{T} = \{ \begin{matrix}( {( 1 + Δ {T}_{t \to 0} )}^{2} - 1 ) \vert 1 + Δ {T}_{t \to t - 1} \vert , & Δ {T}_{t \to 0} > 0 \\ - ( {( 1 - Δ {T}_{t \to 0} )}^{2} - 1 ) \vert 1 - Δ {T}_{t \to t - 1} \vert , & Δ {T}_{t \to 0} \leq 0\end{matrix}$$

$${r}_{L} = \{ \begin{matrix}( {( 1 + Δ {L}_{t \to 0} )}^{2} - 1 ) \vert 1 + Δ {L}_{t \to t - 1} \vert , & Δ {L}_{t \to 0} > 0 \\ - ( {( 1 - Δ {L}_{t \to 0} )}^{2} - 1 ) \vert 1 - Δ {L}_{t \to t - 1} \vert , & Δ {L}_{t \to 0} \leq 0\end{matrix}$$

The present invention also introduces a hyperparameter α∈[0,1] for controlling a weight between r_{T} and r_{L} in a reward r. Furthermore, a penalty term λ*Tx_{fail} for a number of transaction failures is added in the reward function, where Tx_{fail} is the number of transaction failures, and λ is a penalty weight. The final reward function r is defined as α*r_{T}+(1−α)*r_{L}−λ*Tx_{fail}. Note that coefficients α and λ may be set according to actual usage.

In the algorithm, The peer node agent and the ordering node agent each have two networks: an Actor network π and a Critic network Q. In an execution phase, without involving the Critic network, each agent only uses one Actor network π to generate the action α and deploy the action to the blockchain, and then stores an overall experience {s,α,r,s′} in an experience pool D, where s={O_{O},O_{P}}, α={α_{O},α_{P}}, and s′={O′_{O}, O′_{P}} In a training phase, taking the peer node agent as an example, its Critic network extracts action and observation information of itself and other agents from the experience pool, which are used to train a centralized action value network Q_{P}, and then updates its corresponding Actor network π_{P}. MADDPG uses a collective action value function to train the agent to consider the impact of parameters of each node on the performance of Hyperledger Fabric and optimize the blockchain network parameter tuning effect.

During training, the Actor network adjusts its action polices according to the feedback provided by the Critic network, with the goal of improving an expected reward for each action. Meanwhile, Critic optimizes its value estimation according to actual rewards from environmental feedback to guide Actor more accurately. This process is repeated over multiple rounds until the policy converges or a predetermined performance criterion is reached. Through this interactive learning process, the reinforcement learning algorithm can find efficient action policy in complex decision-making environments. The reinforcement learning agent interacts with an environment simulating a blockchain to learn how to select optimal configuration parameters according to the state of the blockchain network, thus improving the performance and effect of the blockchain network.

Specifically, a reinforcement learning training parameter tuning process is as shown in FIG. 7, and includes the following steps:

Step 1: initializing online and target networks of Actor and Critic for agents of two node types, and then initializing a random exploration action process Nₚ, monitoring the deployed Hyperledger Fabric network, receiving the collected initial state s, and performing standardization processing.

Step 2: performing actions according to an agent policy. Specifically, in each iteration, each agent selects an action αᵢ according to the policy π(αᵢ) and exploration noise N.

Step 3: deploying new blockchain network parameters and restarting the Hyperledger Fabric network according to the agent action.

Step 4: using the stress test tool Caliper to test performance of the Hyperledger Fabric to calculate a reward obtained by a currently performed action. Specifically, the Caliper test results in the throughput, average transaction latency and number of transaction failures of the current blockchain network. The reward is calculated using the following formula:

$$α * {r}_{T} + ( 1 - α ) * {r}_{L} - λ * {Tx}_{fail}$$

In the formula, the hyperparameter α∈[0,1] is a reward balance factor, r_{T} is a throughput reward, r_{L} is a latency reward, Tx_{fail} is the number of transaction failures, and λ is a penalty weight. After a reward value is calculated, an average value is assigned to each agent.

Step 5: monitoring the Prometheus and collecting a new blockchain network state s′.

Step 6: storing an experience tuple. Specifically, the current state s, the executed action α, the reward r and a new state s′ are stored as a tuple (s, α, r, s′), and placed in an experience replay buffer D.

Step 7: extracting, by the Critic network, actions and observation information of itself and other agents from the experience pool to train a centralized action value network Q_{P}.

Step 8: updating parameters θ of the Actor network based on a gradient ascent method, and then softly updating parameters of their target networks, that is, after every certain number of iteration steps, the parameters of the online network are directly assigned to the target network.

Step 9: in the training phase, when throughput of five consecutive feedbacks changes by less than 5 tps, or the training time has reached a previously preset time window, output action parameters at this time are recorded and used as optimization parameters for predictive tuning.

S6, in a real IIoT blockchain network environment, deploying parameters optimized in the environment simulating the blockchain to the real environment in case of traffic fluctuation of the blockchain; or abandoning parameter tuning in case of no traffic fluctuation, and repeating steps S2 to S5 to continue a next stage of predictive optimization.

After training, optimization parameters recommended by the reinforcement learning algorithm can be used in a next stage of blockchain adjustment, thus achieving predictive parameter optimization and avoiding lag caused by the training process. When the IIoT transaction changes due to human factors, such as increased data processing due to production changes, timely deployment of the optimization parameters can be achieved.

The previous description of the disclosed embodiments is provided to enable any person skilled in the art to make or use the present invention. Various modifications to these embodiments will be readily apparent to those skilled in the art, and the generic principles defined herein may be implemented in other embodiments without departing from the spirit or scope of the present invention. Thus, the present invention is not intended to be limited to the embodiments shown herein but is to be accorded the widest scope consistent with the principles and novel features disclosed herein.

What is claimed is:

1. A blockchain-based Industrial Internet of Things (IIoT) data management and optimization system, comprising a physical layer, an edge layer, a network interface layer and a cloud layer; wherein
the physical layer comprises a plurality of different IIoT device monitoring systems;
the edge layer comprises an edge server and an edge gateway, the edge server and the edge gateway serve as nodes of a blockchain and are configured to build a an IIoT blockchain network; the IIoT blockchain network processes data storage transaction requests of different IIoT device monitoring systems; the edge gateway is responsible for information transmission and data processing tasks between the physical layer and the edge server; the edge server is responsible for collecting performance and parameter data from the IIoT blockchain network, and preprocessing the collected data to ensure accuracy and consistency of the data; and the edge server is also deployed with a Transformer-based generative model which is configured to predict a blockchain transaction volume in a future period of time according to the preprocessed data to obtain a prediction result, and the prediction result will be configured to simulate an environment configuration for the blockchain;
the network interface layer comprises a blockchain service interface and a 6G network communication interface, which are responsible for communication connection and blockchain service between the edge layer and the cloud layer, and the blockchain service interface is deployed with a smart contract interface; and
the cloud layer comprises cloud servers which, in a cloud server cluster, receive the prediction result from the edge server, deploy an environment simulating the blockchain based on the prediction result, and configure a stress test tool for interactive training of an reinforcement learning algorithm, and during the interactive training, the reinforcement learning algorithm selects optimal configuration parameters based on a state of the blockchain network for deployment in a real IIoT blockchain network environment to improve performance and effectiveness of the blockchain network.

2. The blockchain-based IIoT data management and optimization system according to claim 1, wherein the Transformer-based generative model comprises a unified input representation layer, an encoder, a decoder, a fully connected layer and an output processing layer; the unified input representation layer is configured to transform the data to generate a representation vector input into the model; the encoder comprises two multi-head ProbeSparse self-attention layers, each multi-head ProbeSparse self-attention layer is immediately followed by a feedforward neural network, and the encoder is configured to perform feature extraction processing and output a feature representation of a historical sequence; the decoder comprises a masked multi-head ProbeSparse self-attention layer, a multi-head attention layer and a concatenation layer, and the decoder is configured to fuse a feature extraction result output by the encoder and output a prediction sequence vector; the fully connected layer is configured for feature transformation to transform an internal feature of the model into a prediction result useful for an outer world; and the output processing layer is configured to perform inverse normalization processing on a prediction sequence and output the prediction sequence.

3. A blockchain-based IIoT data management and optimization method, using the blockchain-based IIoT data management and optimization system according to claim 1, comprising the following steps:
S1, deploying a blockchain running environment in an edge gateway and an edge server, and building an IIoT blockchain network using the edge gateway and the edge server as blockchain nodes;
S2, collecting, by the edge server, performance and parameter data of the IIoT blockchain network and preprocessing the collected data;
S3, inputting the preprocessed data into a Transformer-based generative model to predict a blockchain transaction volume in a future period of time;
S4, deploying a training environment simulating a blockchain in a cloud server according to the predicted blockchain transaction volume in the future period of time;
S5, configuring algorithm related operation parameters, interacting with the environment simulating the blockchain configured in the cloud server to train a reinforcement learning algorithm, and outputting configuration parameters of the blockchain network at the moment when the reinforcement learning algorithm training process converges or reaches a time prediction window; and
S6, in a real IIoT blockchain network environment, deploying parameters optimized in the environment simulating the blockchain to the real environment in case of traffic fluctuation of the blockchain; or abandoning parameter tuning in case of no traffic fluctuation, and repeating steps S2 to S5 to continue a next stage of predictive optimization.

4. The blockchain-based IIoT data management and optimization method according to claim 3, wherein a specific method of step S3 is as follows:
Step 1: the preprocessed data passes through a unified input representation layer for data transformation to generate a representation vector input into the model;
Step 2: the representation vector output by the unified input representation layer is put into an encoder for feature extraction processing and a feature representation of a historical sequence is output;
Step 3: a decoder fuses a feature extraction result output by the encoder to output a prediction sequence vector;
Step 4: the prediction sequence vector passes through a fully connected layer for feature transformation to transform an internal feature of the model into a prediction result useful for an outer world; and
Step 5: an output processing layer performs inverse normalization processing on the prediction result and outputs the prediction result.

5. The blockchain-based IIoT data management and optimization method according to claim 4, wherein a specific processing process of Step 1 is as follows:
the unified input representation layer realizes data transformation by combining a global time embedding SE and a local time embedding PE, thus generating a representation vector x^{t}_{feed} input into the model:
$${x}_{feed [ m ]}^{t} = α {x}_{m}^{t} + {PE}_{( N * ( t - 1 ) + m )} + {\sum }_{p} {[ {SE}_{( N * ( t - 1 ) + m )} ]}_{p}$$
where α is a scalar factor configured to balance importance between feature mapping and time embedding, N is a number of samples, m∈[1, N] represents a sample index, and p and t respectively represent a global time type and a number of input sequences; and the global time embedding is represented by a learnable embedding SEₚₒₛ, while the local time embedding is a fixed position embedding in Transformer, and a calculation formula thereof is:
$${PE}_{( pos , 2 n )} = sin ( \frac{pos}{{( 2 N )}^{2 n / {d}_{model}}} )$$
$${PE}_{( pos , 2 n + 1 )} = cos ( \frac{pos}{{( 2 N )}^{2 n / {d}_{model}}} )$$
where n∈[1, . . . , d_{model}/2], pos represents positional information, and d_{model} is a characteristic dimension of the input representation.

6. The blockchain-based IIoT data management and optimization method according to claim 4, wherein a specific processing process of Step 2 is as follows:
firstly, the encoder receives X^{t}_{feed} from the unified input representation layer and inputs the same into a multi-head ProbeSparse self-attention layer I, and a calculation formula thereof is:
$$ProbeSparse\_Att ( Q , K , V ) = Soft max ( \frac{\overline{Q} {K}^{T}}{\sqrt{{d}_{model}}} ) V$$
where Q̅ is a sparse matrix of the same size as Q, and only contains first u most relevant queries under a sparsity metric M(qᵢ, K); and Q∈R^{N×d}^{_{model}}, K∈R^{N×d}^{_{model}} and V∈R^{N×d}^{_{model}} respectively represent a query vector, a key vector and a value vector; these vectors are obtained by performing linear transformation on the input feature, that is, [Q, K, V]=[X^{t}_{feed}·W_{Q}, X^{t}_{feed}·W_{K}, X^{t}_{feed}·W_{V}], where W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V; and d_{model} is a characteristic dimension of the input representation;
where a formula of the sparsity metric M(qᵢ, K) is as follows:
$$M ( {q}_{i} , K ) = ln {\sum }_{j = 1}^{{L}_{K}} {e}^{\frac{{q}_{i} {k}_{j}}{\sqrt{d}}} - \frac{1}{{L}_{K}} {\sum }_{j = 1}^{{L}_{K}} \frac{{q}_{i} {k}_{j}}{\sqrt{d}}$$
where qᵢ represents an ith query vector, K represents a key matrix, kⱼ represents a jth key vector in K, L_{K} represents a length of the key K which is a number of keys, and dis a characteristic dimension of the input;
after processing by the multi-head ProbeSparse self-attention layer I, a feedforward neural network layer I is used for further operation processing; operation steps of the feedforward neural network are as follows: firstly, a convolutional neural network is used to extract advanced features of the data, and then a length of the sequence is reduced by max pooling operation, and a specific process is represented as:
$${X}_{q + 1}^{t} = Max Pool ( ELU ( Conv 1 {d [ {X}_{q}^{t} ]}_{AB} ) )$$
where Conv1d represents one-dimensional convolutional operation, ELU is an activation function, and MaxPool is a max pooling function, [X_{q}^{t}]_{AB} is an output of the multi-head Probesparse self-attention layer I, and X_{q+1}^{t} is an output of the multi-head ProbeSparse self-attention layer I; next, after further feature processing by a multi-head Probesparse self-attention layer II and a feedforward neural network layer II with the same structure as above, the features are concatenated and used as an output X_{Encoder}^{t} of the encoder, a formula thereof is expressed as follows:
$${X}_{Encoder}^{t} = Concat ( FFN 2 ( Probesparse\_Att2 ( {X}_{q + 1}^{t} ) ) ) .$$

7. The blockchain-based IIoT data management and optimization method according to claim 4, wherein a specific processing process of Step 3 is as follows:
firstly, a start marker X^{t}ₜₒₖₑₙ of the sequence and a placeholder X₀^{t} of the prediction sequence are input, and these two pieces of data are combined into an input vector of the decoder through a concatenation operation; the start marker indicates the start of the prediction sequence, and the placeholder X₀^{t}, reserves a position for a future prediction value, and a formula thereof is as follows:
$${X}_{de}^{t} = FeatureConcat ( {X}_{token}^{t} , {X}_{0}^{t} ) ∈ {R}^{( {N}_{token} + {N}_{y} ) \times {d}_{model}}$$
where Nₜₒₖₑₙ is a length of the start marker, and N_{y} is a length of a placeholder of a prediction sequence y; d_{model} is the characteristic dimension of the input representation of the model; X_{de}^{t} represents an input of the decoder at time t, Xₜₒₖₑₙ^{t} represents a start marker of a sequence at time t, and X₀^{t} represents a placeholder of a prediction sequence at time t;
the input data X_{de}^{t} first passes through the masked multi-head ProbeSparse self-attention layer to ensure that the model can only access the information before a current time step when generating prediction for each time step, where a formula of the masked multi-head ProbeSparse self-attention layer is expressed as follows:
$$Mask\_ProbeSparse \_Att ( Q , K , V , M ) = Soft max ( \frac{\overline{Q} {K}^{T}}{\sqrt{{d}_{model}}} ▯ M ) V$$
where □ represents an element multiplication, M is a masked matrix with a shape the same as Q̅K^{T} and the rest of the letters having the same meanings as those of the multi-head ProbeSparse self-attention layer; and the output of the masked multi-head ProbeSparse attention layer is Xₘₐₛₖ.
then Xₘₐₛₖ is put into the multi-head self-attention layer for enhancement processing, and an output result is Attention(Xₘₐₛₖ), and a formula of the multi-head self-attention layer is expressed as follows:
$$Attention ( Q , K , V ) = Soft max ( \frac{{QK}^{T}}{\sqrt{{d}_{model}}} ) V$$
where Q∈R^{N×d}^{_{model}}, K∈R^{N×d}^{_{model}} and V∈R^{N×d}^{_{model}} respectively represent a query vector, a key vector and a value vector; these vectors are obtained by performing linear transformation on the input feature; that is, [Q, K, V]=[Xₘₐₛₖ^{t}·W_{Q}, Xₘₐₛₖ^{t}·W_{K}, Xₘₐₛₖ^{t}·W_{V}]; where W_{Q}∈R^{N×d}^{_{model}}, W_{K}∈R^{N×d}^{_{model}} and W_{V}∈R^{N×d}^{_{model}} are trainable parameter matrices respectively corresponding to Q, K and V;
then the data Attention(Xₘₐₛₖ) output by the multi-head self-attention layer and an output X_{Encoder}^{t} of the encoder are subject to feature concatenation by a concatenation layer to further integrate context information from the encoder, and an output is X_{Con} which is expressed as follows:
X_{Con}=Concat(Attention(Xₘₐₛₖ), X_{Encoder}^{t})

8. The blockchain-based IIoT data management and optimization method according to claim 4, wherein in Step 4, the concatenated data X_{Con} is subject to feature transformation by the fully connected layer, and the layer outputs a prediction sequence for a future sequence X_{t+K}, where K represents a length of the predicted future sequence, a formula thereof is expressed as follows:
$${X}_{t + K} = Fc ( {X}_{Con} )$$
in Step 5, the prediction sequence X_{t+K} is subject to inverse normalization processing by the output processing layer, and a formula of the inverse normalization processing is:
$${X}_{t + K}^{′} = {X}_{t + K} \cdot ( max ( X ) - min ( X ) ) + min ( X )$$
where X′_{t+K} represents a prediction of the blockchain transaction volume in the future period of time based on historical and current states, and the prediction result will be configured to simulate an environment configuration for a blockchain, and K represents the length of the predicted future sequence.

9. The blockchain-based IIoT data management and optimization method according to claim 3, wherein in step S4, the operation of deploying the environment simulating the blockchain comprises the following steps:
Step 1: environment configuration file modification: modifying a network node configuration file and a smart contract storage scale configuration file according to a number of blockchain network nodes and node organization information and channel configuration condition collected in step S2;
Step 2: configuring and starting a Hyperledger Fabric network, defining an organization and nodes, then generating a network configuration file and an encryption material, and then starting network services comprising ordering services, node consensus services and chain code installation deployment;
Step 3: using Prometheus to monitor state of the blockchain nodes, and acquiring state information of each current blockchain node; and
Step 4: starting a stress test tool Caliper and obtaining performance test results of an initial blockchain network.

10. The blockchain-based IIoT data management and optimization method according to claim 3, wherein in step S5, the reinforcement learning algorithm training parameter tuning process comprises the following steps:
Step 1: initializing online and target networks of Actor and Critic for agents of two node types, and then initializing a random exploration action process Nₚ, monitoring the deployed Hyperledger Fabric network, receiving the collected initial state s and performing standardization processing;
Step 2: performing actions according to an agent policy: in each iteration, each agent selects an action αᵢ according to the policy π(αᵢ) and exploration noise N;
Step 3: deploying new blockchain network parameters and restarting the Hyperledger Fabric network according to the agent action;
Step 4: using the stress test tool Caliper to test performance of the Hyperledger Fabric to calculate a reward obtained by a currently performed action; and after the reward value is obtained by calculating, taking an average value to allocate to each agent;
Step 5: monitoring the Prometheus and collecting a new blockchain network state s′;
Step 6: storing an experience tuple: storing the current state s, the executed action α, the reward r and a new state s′ as a tuple (s, α, r, s′), and placing the tuple in an experience replay buffer D;
Step 7: extracting, by the Critic network, actions and observation information of itself and other agents from the experience replay buffer D to train a centralized action value network Qₚ.
Step 8: updating a parameter of the Actor network based on a gradient ascent method, and then softly updating parameters of their target networks, that is, after every certain number of iteration steps, the parameters of the online network are directly assigned to the target network; and
Step 9: in the training phase, when throughput of five consecutive feedbacks changes by less than 5 tps, or the training time has reached a previously preset time window, output action parameters at this time are recorded and used as optimization parameters for predictive tuning.
